(19) United States
(12) Patent Application Publication
(10) Pub. No.: US 2012/0054100 A1
(43) Pub. Date: Mar. 1, 2012

(54) COLLECTIVE DONATION MANAGEMENT AND AUTOMATED ALLOCATION AND DISBURSEMENT SYSTEM

(76) Inventor: Michael L. Pfohl, Madison, WI (US)

(21) Appl. No.: 12/858,214

(22) Filed: Aug. 17, 2010

Related U.S. Application Data
(60) Provisional application No. 61/366,364, filed on Aug. 31, 2010.

(51) Int. Cl. G06Q 40/00

(52) U.S. Cl. 705/44

(57) ABSTRACT

The invention is a computer implemented method for tracking, managing, and automating management and compliance of multiple organizations' data and information related to collective donation organizations such as political conduits. The method includes tracking multiple donors' contact information, pending transactions, previous donations, and deposits; multiple campaigns' contact information, pending transactions, previous donations received, and disbursement from the collective organization; donor donation preferences; campaign preference tags; automatically generating a suggested disbursement plan based on a multitude of factors; individualized automated donor notification and request for approval; reporting and compliance for election law; bank account automatic checking withdrawal file creation and integration; and reports based on user entered data.

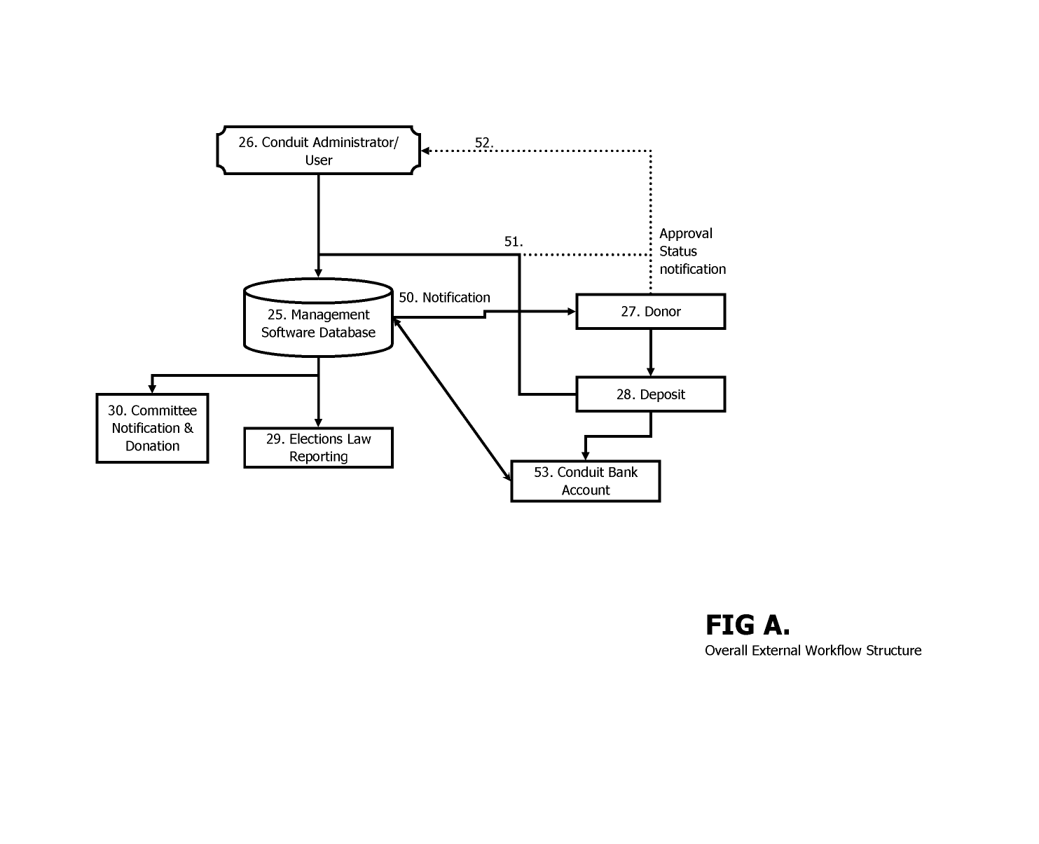

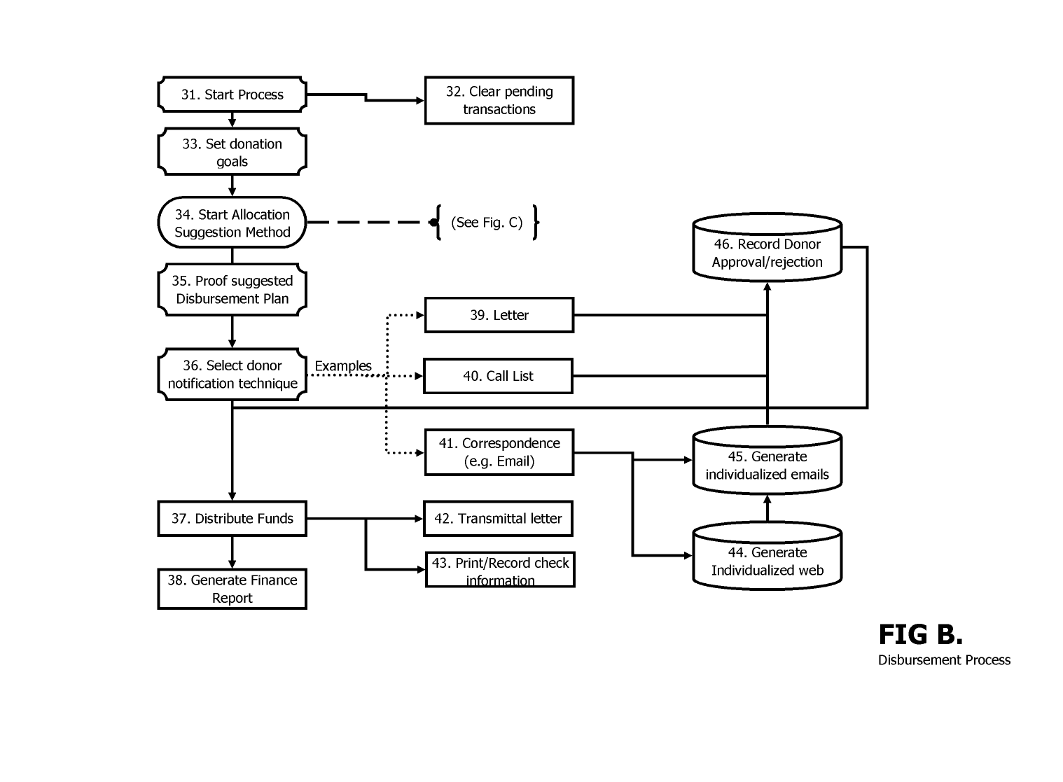

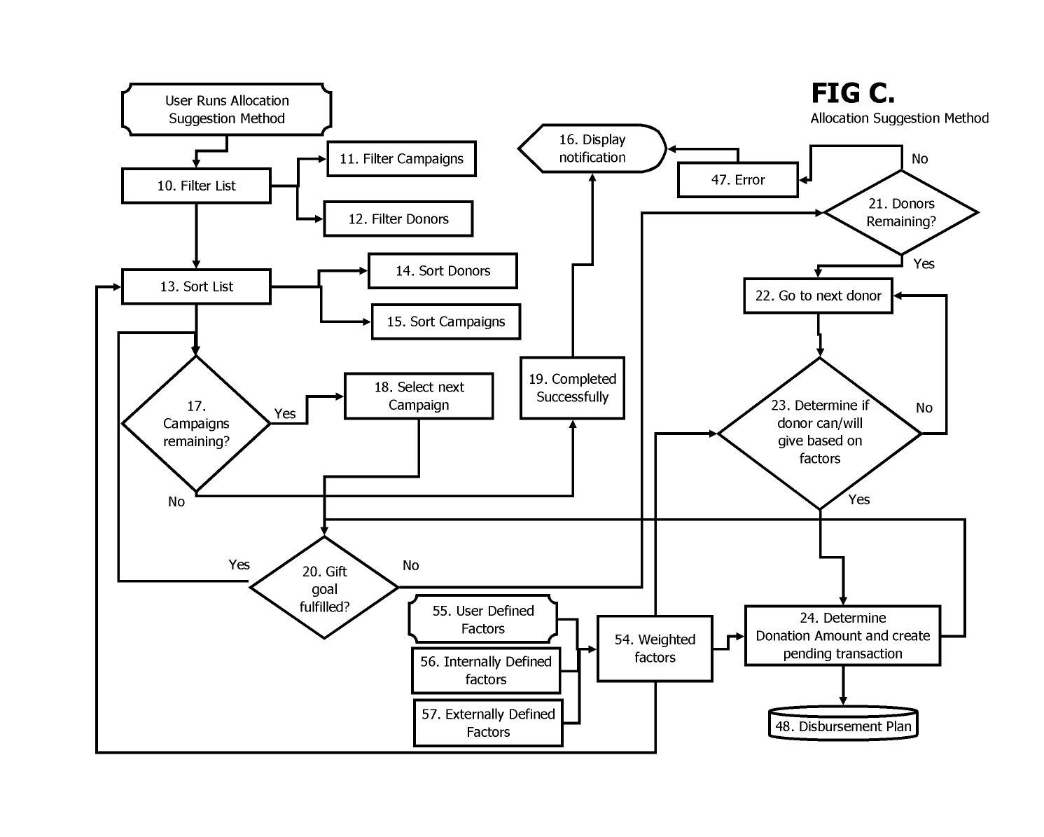

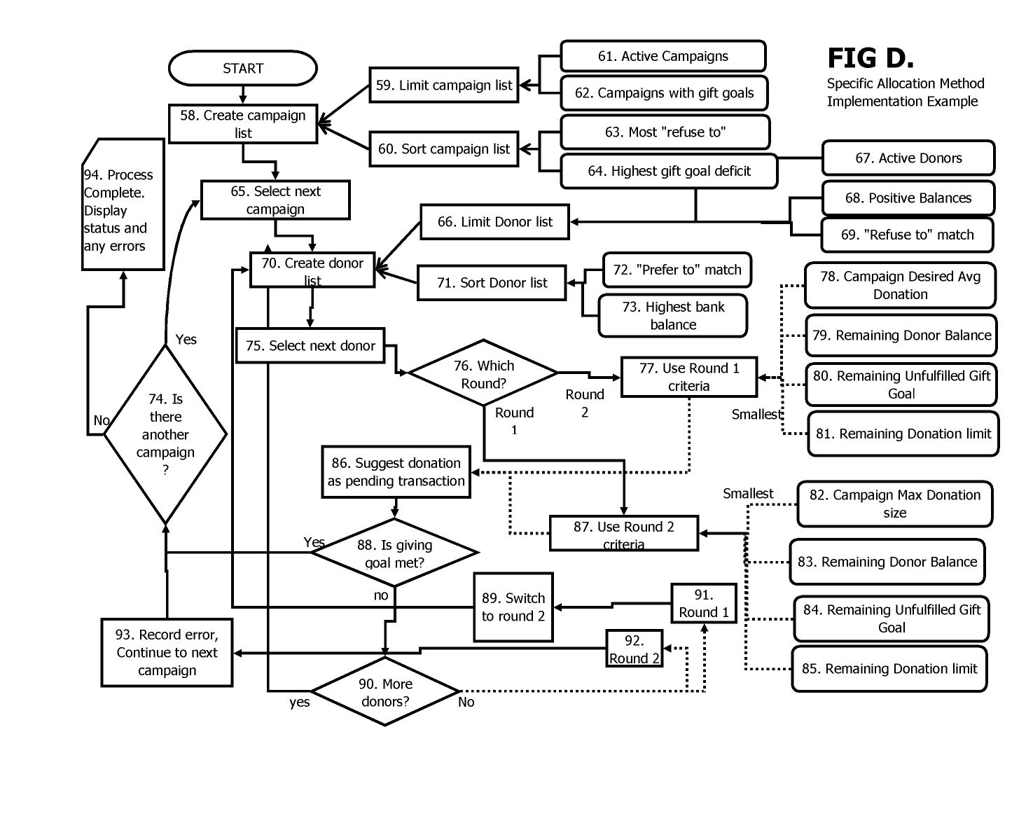

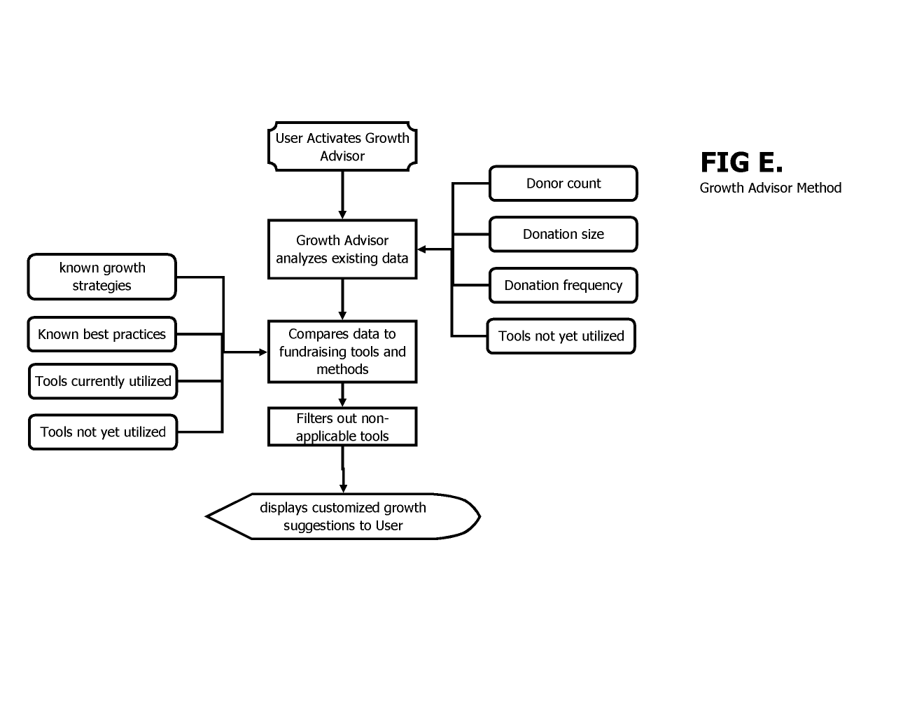

### RELATED APPLICATIONS

Provisional application No. 61366364, filed on Jul. 21, 2010.

### FIELD OF INVENTION

The present invention relates to data processing by digital computers, and in particular, to processing data representative of financial transactions.

### BACKGROUND

A collective donation organization consists of any entity which organizes and advises many donors who have allocated a specified amount of funds for disbursement to various entities at the advice of the collective organization (“Collective Donation Organization”). For this invention, the preferred embodiment for such an organization is a Political Conduit (defined below). For the purpose of simplicity in this document, a Political Conduit will be the primary example used for this invention's implementation.

Other embodiments include any organization that seeks to provide advice to its collective donors as to which organizations they should donate funds. One embodiment includes donors contributing to a central fund, which then, upon appropriate donor approval, may release the funds to specified organizations. Another embodiment includes direct donations from the donor to the specified organization facilitated by and on the advice of the Collective Donation Organization.

The invention disclosed herein includes methods to organize and facilitate the administrative activity of these Collective Donation Organizations throughout the donation process.

One embodiment of Collective Donation Organizations is a Political Conduit. Political Conduits are entities governed under state elections law as a category of political donation. Other common types of political donations the public may be more familiar with are donations from an individual, and donations from political action committees (“PACs”). Conduits exist in election law as a middle ground between PAC and individual donations in that they count toward a campaign's individual donation limits, rather than PAC donation limits but still allow an organization to help direct donations. The term “candidate” or “committee” may be used interchangeably in this document.

An example of how a political conduit may work under Wisconsin law is as follows:

A group of donors will individually deposit money (either one-time or monthly) into the Collective Donation Organization's designated bank account. The conduit administrator must track how much each donor has put into the conduit or account. Later, the administrator decides that because the organization has endorsed three (3) candidates, and the conduit account has $2000 in it. The Collective Donation Organization would like to donate$500 two candidates each and $1000 to the third candidate. Before the administrator sends the campaigns those amounts, he or she must first contact every single donor in the conduit or collective donation group and get permission to release their funds to the recommended candidate. The administrator will then contact the donor and say, for example, “You have put $100 in the conduit account this year, we'd like to release $50 to candidate X and $50 to candidate Y.” The donor can either approve that or insist their money be sent somewhere else (or nowhere at this time). Once the administrator has the approval from all of the donors, the amounts can be donated to the campaigns which are notified as to which donors made up each portion of that check.

This process is time consuming for the administrator and involves a lot of record keeping and compliance with both the bank and the state elections board (also can be known as the Government Accountability Board).

Additionally, before the administrator contacts a donor to request permission to release their funds, the administrator needs to prepare a disbursement plan on how to divide up the money each donor has in the conduit to reach the desired donation goals. Before this invention, this process would usually be done manually such as with a spreadsheet system. If a donor disagrees with the administrator's donation suggestion, the administrator must go back to square one and manually move other donors and donations around to fill the newly created financial hole.

### SUMMARY OF THE INVENTION

The invention is based on the recognition of a need to automate the management, allocation, and distribution of a Collective Donation Organization's funds in a quick and user-friendly way.

The method and systems disclosed herein provide a way for administrators of political conduits or other Collective Donation Organizations (“Users”) to no longer be required manually track each individual donor's bank account, no longer be required manually create disbursement plans to meet the conduit's donation goals based on individual donor transactions, as well as provides a way to automate the approval seeking process required to release a donor's conduit funds, and the related disbursal process.

In one aspect, the invention features a computer implemented method to be carried out in a network of interconnected computer systems. In another aspect, the invention features a computer-implemented method carried out on a single computing system using installed software. One method includes prompting the user through a series of steps called the “Distribution Process.” These steps include preparing the database to be a new distribution process, setting donation goals for selected campaigns, initiating the allocation method of reviewing the disbursement plan, notifying donors and seeking approval, approving or modifying the disbursement plan, generating transmittal letters to a each affected committee, printing and tracking checks for amounts specified in the disbursement plan, and creating finance reporting forms in compliance with election law.

One practice of the invention is to create a computer-generated disbursement plan created by the allocation method. The automated allocation method evaluates multiple sets of criteria in generating this plan.

One example of criteria evaluated by the automated allocation method is donor preference. One example of donor preference would be matching a donor who has indicated they are “Pro-Life” with a candidate who has been assigned a “Pro-Life” preference tag. Another example is a donor would prefer to give to candidates in the “Milwaukee Region” before donating to candidates elsewhere. Conversely, a donor can be tagged with exclusionary preferences. One example of an exclusionary preference would be a donor who has been assigned as never wanting to give to a campaign tagged with “Pro-Life.”

Other criteria examples include but are not limited to finance law limits and bank account information.

In another aspect, the invention provides an automated process for contacting those donors to request approval before the monies may be disbursed in compliance with election law. One example of this practice includes automatically generating correspondence such as individualized emails to every affected donor with a link to an individualized webpage listing their donations they may either reject or approve.

Other practices of this invention include recording the input, including approval or rejection, from the donor on their individualized donor page.

In another aspect, the invention features a method that includes maintaining a privately-available website configured to execute software for carrying out any of the foregoing computer-implemented methods.

In another aspect, the invention includes a computer-readable medium having encoded thereon software for causing a computer to execute any of the foregoing methods.

The invention can be implemented to realize one or more of the following advantages. At least one implementation of the invention provides all of the following advantages.

The conduit administrator can track all administrative and reporting needs for their conduit including generating finance reports, tracking bank balances, and the status of given pending or approved transactions.

One user with the proper permissions from each conduit, can access multiple conduit accounts with a single login.

A single user managing a conduit comprised of thousands of donors giving to dozens of campaigns can instantly and automatically generate a disbursement plan for each donor and each campaign.

A single user can instantly seek approval from each donor maximizing their response while minimizing effort.

Other features and advantages of the invention will be apparent from the following claims, the detailed description, and the accompanying drawings.

### DESCRIPTION OF DRAWINGS

FIG. A—Overall External Workflow Structure—example of invention's use within a conduit organization's workflow structure

FIG. B—Distribution Process

FIG. C—Allocation Method

FIG. D Specific implementation example of allocation method

### DETAILED DESCRIPTION

### Overall Structure: FIG. A

As shown in FIG. A, the invention works as a central hub for managing communication and workflow involved with administering a political conduit. The conduit administrator 26 enters information about the conduit, including donor information 27, committee information 30, and other information such as committee donation targets consistent with their political goals in order to better inform the automated allocation method FIG. C.

The invention 25 then creates a disbursement plan 48 during the disbursement process FIG. B which the invention conveys to specific donors 27 via various notification methods 50. The donors may then respond directly through means such as via personalized web-pages 44 and 51 or they may respond directly to the conduit administrator 26 and 52 who enters that information back into the database system 25.

The database system 25 also tracks other information, such as deposits 28 into the conduit fund 53 by donors 27 whether it be one time deposits or automatic monthly payment. An example of an automatic monthly payment would be automatic check withdrawal (“ACH”). The invention can generate these ACH files to send to the bank 53 to process these recurring transactions. Another example of automatic monthly payment is tracking a recurring monthly donation into the conduit via credit card.

The invention can also generate and manage communication sent from the conduit administrator 26 to a given committee 30 including transmittal letters 42 and contribution checks 43.

The invention also manages communication with other organizations, such as by generating finance reports 38 to comply with state and federal election boards.

### Disbursement Process: FIG. B

When the conduit administrator (“User”) 26 is ready to disburse conduit funds to committees 30 he or she may choose to use the automated disbursement process outlined in FIG. B whereby the user is walked through the necessary steps to release conduit funds. An example of how these steps can be implemented includes:

First, the database is prepared to begin a new distribution process 31 by clearing any old pending and unapproved transactions 32.

Next, the User sets individualized donation goals 33 to each campaign committee 30 along with other preferences. One example of a preference for donations to that committee includes setting the desired suggested average donation size from any one donor to that campaign by the Automated Allocation Suggestion Method 34. For example, while the maximum an individual may be able to give under the law to that campaign may be $500, the User may specify that when possible, only $25 at a time should be allocated to a given campaign.

The User then initiates the automated allocation method 34.

The User is then prompted to review 35 the disbursement plan 48 created by the automated allocation method 34. The user is provided with opportunities to manually make changes if the user desires.

Next, the User may select from several donor notification techniques 36 in order to seek approval for the suggested pending donations 48. Notification techniques include but are not limited to the following: the automated email 41. This process involves the database software 25 automatically generating customized and individualized webpages 44 for each donor with a pending transaction 48. A correspondence, such as an email or text message, 45 is then automatically generated to that donor. That correspondence may include the information regarding the disbursement plan 48 as it relates to suggested pending donations from that given donor, along with a link to that donor's individualized webpage 44 or it may just include a link to the personalized web site where this information is provided. The donor may respond with their approval or rejection of their pending donation plan 44 by replying to the User via email 27 through their individualized website or directly through mail, telephone, facsimile, etc. 44 which is then recorded in the system 46.

Other examples of seeking notification include generating personalized letters 39 to each donor with their suggested donation plan 44, or generating call lists 40 with the donation plan and donor contact information. The conduit administrator may then use this call list to personally call each donor and verbally request approval for the donations specified in the disbursement plan 48.

Once the pending transactions have been approved, rejected, or modified 46, the User may distribute the funds. The database software 25 creates a transmittal letter 42 to each affected campaign regarding the details of the conduit donation. Examples of included details are each individual donor's name, contact information, occupation, employer, and donation amount. The User then has the option of printing donation amounts directly onto checks or externally distributing the funds and recording the details about that transaction, such as by check numbers or direct deposit information 43.

In a different practice of this method, once the disbursement plan is approved and the User is ready to release the funds, the monies may be directly deposited in each of the campaigns' bank accounts.

In a different embodiment of a Collective Donation Organization such as a philanthropic organization, a different practice of this method may include directly withdrawing the donation from the donor's bank account and directly depositing it into the specified organization's bank account. In this practice, the donation is never directly deposited into the Collective Donation Organization's common bank account.

The final step in the disbursement process is the automatic generation of a finance report 38 to be submitted to State or Federal elections boards 29 in compliance with applicable elections law.

While the workflow is presented in linear fashion herein, in practice the User 26 can enter any segment of the workflow at any time. One example would be if the user began by setting donation goals 33, then skipped the automated allocation method section to manually add or edit pending donations 35.

### Allocation Method: FIG. C

One example of how one aspect of the invention can be used in practice is shown in a generic example through FIG. C a more specific example of implementation is shown in FIG. D. In FIG. C, after the User 26 has initiated the automated allocation method 34, software database 25 suggests a disbursement plan 48 to match the User's 26 donation goals 33. This process is conducted ‘behind the scenes’ on the server and does not require further user interaction.

The first step in the automated allocation method 34 is to filter the list, by using several factors 54, limiting the campaigns 11 and donors 12 to the ones needing processing. One example of a limiting factor for a campaign is if the User 26 did not delineate a donation goal 33 for that campaign. One example of a limiting factor for a donor 12 is if the donor's account balance in the conduit is empty.

The weighted factors 54 used throughout this process are drawn from many sources. One source is user defined factors 54 such as a donor's political preference and a matching campaign's issue position, region, or endorsement status. Another example is internally defined factors 56, such as remaining bank balances in regards to pending transactions. Another example is externally defined factors 57, like limits placed on donation sizes by election law.

Some factors taken into account for the automated allocation method are as follows but not limited to: Committee preference and description tags; Donor donation preferences and tags; Each donor's previous donations to campaigns within the conduit; Each donor's previous donations to campaigns outside of the conduit; Desired total donation goal by conduit to committee; Remaining amount available in each donor's conduit account; Total amount available in conduit fund; Status of a given donor (active or inactive); Status of a donor as a lobbyist; Whether a committee is accepting lobbyist money or not; Desired average donation size by conduit administrator; Donation limits to the given campaign per cycle; Total donation limit per year; Remaining gift goals to each committee.

For a specific example of how these factors can be combined, weighted, and sorted to generate individual suggested donation amounts, see FIG. D.

The automated allocation method 34 then sorts the remaining list of donors 14 and campaigns 15 throughout the process (for example, at both at points 18 and 22 in FIG. C) in order to best prioritize the list to meet the User's donation goal 33. The sort order can also draw upon several weighted factors 54.

The automated allocation method 34 then cycles through each remaining campaign 18, then each donor as it relates to that campaign 21 suggesting donations based on a variety of weighted factors (54) to determine if the donor is likely or able to give 23, and if so, how much 24. Examples of weighted factors used to determine how much to assign as the pending donation amount include but are not limited to the maximum donation limit to a campaign; remaining balance in the donor's account including pending transactions; previous donation giving history, and the difference between campaign's donation limit per cycle and how much that donor has already given to that campaign for the current cycle.

Once a donation amount is determined, a pending transaction 24 is created for each of these donors for later approval during the notification and approval process 36.

This process is repeated with each donor 22 and each committee 18 until errors prevent continuing 47 or a disbursement plan fulfilling the gift goal to each campaign is successfully completed 19. The sum collection of these pending transactions comprises the disbursement plan 48.

The embodiment exemplified by FIG. C is only one example of how the invention's use of various preferences and weighted factors matches donors with campaigns to meet desired donation goals. The invention is not solely limited to this iteration of logical workflow. An example of a different workflow pattern would be inverting the order enumerated in FIG. C. by switching the location of interchangeable module 18 (campaign) with interchangeable module 22 (donor), thereby stepping through the process first by donor, and then sub-grouped by campaign, rather than by campaign, and sub-grouped by donor.

While a political conduit is technically one bank account that multiple donors deposit into, software database tracks the balance of each individual donor's donations, withdrawals, and pending transactions as if they were separate accounts. At any time, the User 26 can retrieve activity information through individualized reports and forms regarding the accounts of specific donors 27 or committees 30.

In some instances, a user may access the software database via ‘Director View’ where a User who has security permissions to view multiple conduit accounts may view summary information from multiple conduits at once, and then select a specific conduit to enter for further information of necessary.

### Specific Example of Allocation Method: FIG. D

An example of one specific implementation of the automated suggestion method outlined in FIG. C can be seen in Example 1.

In Example 1, the method starts by first creating a campaign list 58. This list is made by first limiting the list 59 to campaigns previously designated by the user as “active” 61 and excluding any campaigns without a previously designated “Gift Goal” 62. The “Gift Goal” is the amount specified by the conduit administrator as the desired end total to each campaign through the finalized disbursement plan.

The campaign list 58 is then sorted and prioritized 60 by campaigns with the most “refuse to give” tags associated with it 63 and then by the campaigns with the highest gift goal deficit 64. “Refuse to Give” tags are tags that when associated with a related donor preference tag 69 will prevent a pending transaction 86 from being created for that donor. The gift goal deficit is the difference between the gift goal remaining, and the total dollar amount of pending transactions 86 to that campaign.

With the campaign list 58 limited 59 and sorted 60 the method then selects the first campaign in the list 65 and then creates a donor list of possible donors for that campaign 70. This donor list is made by first limiting the list 66 to donors previously designated by the user as “active” 67; excluding donors without positive balances in their accounts 68; and excluding donors with a user-predefined “refuse to” tag 69 matching a related tag to that campaign. An example of a “refuse to” tag is if the donor has a “refuse to give to Pro-Life” tag, and the campaign is tagged with “Pro-Life.”

The donor list 70 is then sorted 71 by first prioritizing donors with a user-predefined “prefer to” tag 72 matching a related tag to that campaign. An example of a “prefer to” tag is if the donor has a “prefers to give to Madison area” tag, and the campaign is tagged with “Madison area.” The remaining donors on the donor list 70 are sorted to prioritize highest remaining bank balance 73 to the top of the list.

With the donor list 70 limited 66 sorted 71, the method then selects the first donor in the list 75. The first pass through 76 the donor list is considered “Round 1.” In this round, a donation is suggested 86 based on Round 1 criteria 77. The donation amount suggested 86 will be whichever is small of the following amounts: the desired donation size the user previously specified for that campaign 78; the remaining balance in the Donor's account 79; the difference between that campaign's Giving Goal and that committee's now pending transactions 80; and the difference between campaign's donation limit and how much that donor has already given to that campaign 81.

The method then checks to see if, with this new pending donation 86, the desired gift goal to the campaign has been met 88. If it has, then it proceeds to restart the process with the next campaign 74. If it hasn't, then it proceeds to the next donor 75 and continues the process for each donor. Once all donors in the list have been exhausted 90 then it continues with the process to finish fulfilling the gift goal to this committee by switching from Round 1 style 91 to Round 2 style 89, and starts at the top of the donor list once again 70.

After once again limiting 66 and resorting 71 the donor list, it selects the first donor in the list 75 and suggests a donation amount using Round 2 criteria 87. The donation amount suggested 86 will be whichever is the smallest of the following amounts: the maximum donation size allowable for that campaign within finance law limits 82; the remaining balance in the Donor's account 83; the difference between that campaign's Giving Goal and that committee's now pending transactions 84; and the difference between campaign's donation limit and how much that donor has already given to that campaign 85.

The method then continues as before, suggesting donations for each remaining donor in the list until either the gift goal is met 88 or there are no more donors 90. If the goal is not met and there are no more donors, the error is recorded 93 and the method continues to the next campaign 74. If the goal is met, then the method checks if there are remaining campaigns to fulfill 74. If not, then the process is complete 94. If campaigns remain, then the next campaign is selected 65 and the process continues once again.

### Embodiments

Embodiments of the invention can be implemented in digital electronic circuitry, or in computer hardware, firmware, software, or in combinations thereof. Embodiments of the invention can be also implemented as a computer program software, i.e., a computer program tangibly embodied in an information carrier, such as a machine-readable storage device, or tangibly embodied as a propagated signal, for execution by, or to control the operation of, a data processing apparatus. An exemplary data processing apparatus can include a programmable process, a computer, or multiple computers.

A computer program can be written in any form of a programming language, including compiled or interpreted languages, and can be deployedi n any form, including as a stand-alone program, or as a module, component, subroutine, or other unit suitable for use in a computing environment. A computer program can be deployed for execution on one computer, or on multiple computers. In the latter case, the multiple computers can be at one site, or distributed across multiple sites interconnected by a communication network.

The method steps described herein can be performed by one or more programmable processors executing a computer program that operates on input data and generates output. Method steps can also be performed by, and the apparatus of the invention can be implemented as, special purpose logic circuitry, e.g. an FPGA (field programmable gate array) or an ASIC (application specific integrated circuit).

The method steps disclosed herein illustrates a particular architecture for deploying the software. This software typically runs on a server and is accessed through a website, however the actual machine that carries out these instructions is not significant.

Other information carriers suitable for embodying computer-program instructions and data include all forms and non-volatile memory, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and memory can be supplemented by, or incorporated in, special purpose logic circuitry.

It is to be understood that the foregoing description is intended to illustrate and not to limit the scope of the invention, which is defined by the scope of the appended claims. For example, various additions to the list of factors taken into account by the automated allocation method will occur over time. Another example may include other automated methods for contacting donors of the automated disbursement plan created for them including automatically by phone. Other embodiments are within the scope of the following claims.

It is also to be understood that while the invention has been described in conjunction within the detailed description thereof, the foregoing description is intended to illustrate and not limit the scope of the invention, which is defined by the scope of the appended claims. Other aspects, advantages, and modifications are within the scope of the following claims.

It is also to be understood that while the examples provided for the invention above apply specifically to political conduits, the scope of the invention's use is not limited to political conduits but embodiments of the methods herein may also apply to any entity which provides specific donation advice to a group of donors who must provide specific authorization and approval before their funds may be released.

Having described the invention, and a preferred embodiment thereof, what is claimed is:

1. A computer-implemented method for automating the disbursement process of a Collective Donation Organization comprising:
(a) Automatically generating a disbursement plan;
(b) Automating the donor approval seeking process to approve, reject, or modify suggested donations from the disbursement plan before funds may be released to specified campaigns or organizations.
(c) Releasing funds according to a disbursement plan from a collective donation account.

2. The method of claim 1, wherein automatically generating a disbursement plan comprises the use of an automated allocation algorithm, without the need for human intervention, a computer-implemented method of generating a disbursement plan for multiple donors and campaigns from a single collective donation organization.

3. The method of claim 2, wherein a disbursement plan is comprised of a list of donors and suggested donation amounts out of the collective donation account to specified campaigns.

4. The method of claim 2, where the disbursement plan is comprised of a weighted list of multiple factors used in combination to automatically generate the disbursement plan.

5. The method of claim 4, where weighted factors are comprised of internally defined, user defined, or externally defined factors.

6. The method of claim 1, wherein the approval seeking process is comprised of automated systems for contacting donors in the disbursement plan.

7. The method of claim 6, wherein contacting donors is comprised of automated generation of written correspondence to each donor.

8. The method of claim 7, wherein the correspondence is comprised of an automated generation of individualized donor approval links to an individualized website to record the donor's approval or rejection.

9. The method of claim 6 is comprised of the use of automatic generation of call lists for each donor for use by persons to call upon donors.

10. The method of claim 1, the method of seeking approval is comprised of seeking additional information from the user by providing a process to detail the disbursement plan for the user through.

11. The method of claim 1 wherein the computer-implemented method automatically generates files and tracking data related to automatic periodic donations by pre-specified Collective Donation Organization donors.

12. The method of claim 11, wherein automatic periodic donations comprises donors who have elected to donate monthly via credit card or automatic check withdrawal (ACH).

13. The method of claim 11, wherein generating files is comprised of the creation of the ACH file to send to the collective donation organization's bank ACH system.

14. The method of claim 11, wherein tracking data is comprised of automatically accounting for periodic automatic deposits to ensure internal bank balance estimates are correct.

15. The method of claim 1, wherein the computer-implemented method is comprised of maintaining a constant record of each donor's account within the Collective Donation Organization, including deposits, withdrawals, and pending transactions.

16. The method of claim 1 wherein the computer-implemented method is comprised of providing a user with the appropriate permission levels to see multiple Collective Donation Organization accounts at once.

17. The method of claim 1 wherein the computer-implemented method is comprised of a finance report for the Collective Donation Organization in compliance with appropriate elections law.
